(19) United States
(12) Patent Application Publication
(10) Pub. No.: US 2010/0166464 A1
(43) Pub. Date: Jul. 1, 2010

(54) LIGHT SCANNING UNIT CAPABLE OF COMPENSATING FOR ZIGZAG ERROR, IMAGING APPARATUS HAVING THE SAME, AND METHOD OF COMPENSATING FOR ZIGZAG ERROR OF THE LIGHT SCANNING UNIT

(75) Inventor: Hee-sung CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co. Ltd., Suwon-si (KR)

(21) Appl. No.: 12/647,169

(22) Filed: Dec. 24, 2009

(30) Foreign Application Priority Data
Dec. 29, 2008 (KR) 2008-135742

(51) Int. Cl. G02B 26/10; G03G 15/04

(52) U.S. Cl. 399/221; 359/212.2; 359/205.1; 359/213.1; 399/218

(57) ABSTRACT

Provided are a light scanning unit capable of compensating for a zigzag error, an imaging apparatus having the same, and a method of compensating for a zigzag error of the light scanning unit. The light scanning unit may scan light beams using an oscillation mirror configured to rotatably oscillate. The light scanning unit may deflect light beams in a sub-scan direction in synchronization with the rotatable oscillation of the oscillation mirror, thereby compensating for a zigzag error caused by reciprocative scanning of the oscillation mirror.

### CROSS-REFERENCE TO RELATED APPLICATIONS

This application claims the benefit of Korean Patent Application No. 10-2008-0135742, filed on Dec. 29, 2008, in the Korean Intellectual Property Office, the disclosure of which is incorporated herein in its entirety by reference.

### BACKGROUND

1. Field of the Invention

The present general inventive concept relates to a light scanning unit capable of compensating for a zigzag error, an imaging apparatus having the same, and a method of compensating for a zigzag error of the light scanning unit.

2. Description of the Related Art

In an electrophotographic imaging apparatus, formation of an image may involve scanning light beams onto a surface of a drum using a light scanning unit to form an electrostatic latent image, developing the electrostatic latent image using a developing agent, such as a toner, to form a developed image, transferring the developed image onto a printing medium, and fusing the transferred developed image onto the printing medium.

A light scanning unit of one type of conventional imaging apparatus employs a polygonal mirror driven by a spindle motor. However, due to speed limitations of the polygonal mirror, the noise of the spindle motor caused during high-speed drive, and the size of the light scanning unit in the conventional imaging apparatus, newer technologies are replacing the spindle motor and polygon mirror. A light scanning unit using a micro-electro-mechanical-system (MEMS)-type oscillation mirror has lately attracted considerable attention because the light scanning unit using the MEMS-type oscillation mirror is capable of scanning light beams in two directions at high speed and may be miniaturized using a semiconductor fabrication process.

### SUMMARY

The present general inventive concept provides a light scanning unit capable of compensating for a zigzag error caused when the light scanning unit includes a beam deflector having an oscillation mirror configured to rotatably oscillate, an imaging apparatus having the light scanning unit, and a method of compensating for a zigzag error of the light scanning unit.

Additional aspects and utilities of the present general inventive concept will be set forth in part in the description which follows and, in part, will be obvious from the description, or may be learned by practice of the general inventive concept.

According to an aspect of the present general inventive concept, there is provided a light scanning unit for scanning a light beam in a main scan direction orthogonal to a sub-scan direction onto a scanned surface moving in the sub-scan direction. The light scanning unit may include: a light source configured to emit a light beam; a beam deflector configured to reciprocatively scan the light beam emitted by the light source, the beam deflector including an oscillation mirror configured to rotatably oscillate; and a compensation device configured to compensate for a zigzag error caused by reciprocative rotation of the beam deflector.

The compensation device may include: an electro-optical crystal having a refractive index that varies according to an applied voltage; and an electrode unit configured to apply a voltage to the electro-optical crystal. The electro-optical crystal may be one of lithium niobate (LiNbO₃) and a K—Ta—Nb crystal (KTN).

The compensation device may be located in a light path interposed between the light source and the beam deflector.

The compensation device may compensate scan lines of light beams formed on the scanned surface due to the reciprocative scanning of the beam deflector to be parallel to the main scan direction. Alternatively, during the reciprocative scanning of the beam deflector, the compensation device may allow a first light beam corresponding to a light beam scanned in a first direction on the scanned surface to travel straight through the compensation device to form a first scan line on the first surface and may deflect a second light beam corresponding to a light beam scanned in a second direction opposite to the first direction to travel along a scan line parallel to the first scan line.

The light scanning unit may further include a synchronous signal detection system configured to detect a signal synchronized with the reciprocative scanning of the beam deflector.

The light scanning unit may further include a collimating lens configured to collimate a light beam. The collimating lens may be located between the light source and the compensation device.

The light scanning unit may further include a cylindrical lens configured to condense a light beam on the beam deflector in the sub-scan direction. The cylindrical lens may be located between the light source and the compensation device.

The light scanning unit may further include an optical imaging lens configured to image light beams reciprocatively scanned by the beam deflector onto the scanned surface at uniform speed.

According to another aspect of the present general inventive concept, there is provided an imaging apparatus including: a photoconductive medium having a scanned surface; and the above-described light scanning unit.

According to another aspect of the present general inventive concept, there is provided a method of compensating for a zigzag error of a light scanning unit for reciprocatively scanning a light beam in a main scan direction orthogonal to a sub-scan direction onto a scanned surface moving in the sub-scan direction. The method may include deflecting a light beam incident to the oscillation mirror in the sub-scan direction in synchronization with rotatable oscillation of the oscillation mirror to compensate for a zigzag error caused by reciprocative scanning of the oscillation mirror.

According to another aspect of the present general inventive concept, there is provided a method for compensating for a zigzag error of a light scanning unit comprising a light source, a compensator, and a beam deflector, the method comprising: emitting a light beam from the light source, deflecting the light beam from the light source with the beam deflector to reciprocatively scan the light beam onto a scanned surface, the scanned surface moving in a first direction, and adjusting the light beam from the light source in the first direction with the compensator in synchronization with the reciprocative scanning of the beam deflector to generate adjacent scan lines traveling in opposite directions parallel to each other on the scanned surface. The scan lines on the scanned surface may be orthogonal to the first direction.

The compensator may be located along a path of the light beam between the light source and the beam deflector. A voltage may be applied to the electro-optical crystal to redirect the beam of light onto the beam deflector at an angle different from an angle at which the beam of light entered the electro-optical crystal from the light source.

### BRIEF DESCRIPTION OF THE DRAWINGS

The above and other features and advantages of the present general inventive concept will become more apparent by describing in detail embodiments thereof with reference to the attached drawings in which:

FIG. 1 is a construction diagram of a light scanning unit according to an embodiment of the present general inventive concept;

FIG. 2 is a schematic construction diagram of a sub-scan section of the light scanning unit of FIG. 1;

FIG. 3 is a diagram of a compensation device used for the light scanning unit of FIG. 1, according to an exemplary embodiment of the present general inventive concept;

FIG. 4 is a diagram illustrating a method of compensating for a zigzag error of the light scanning unit of FIG. 1, according to an embodiment of the present general inventive concept;

FIG. 5 is a diagram of a compensation device used for the light scanning unit of FIG. 1, according to another exemplary embodiment of the present general inventive concept;

FIG. 6 is a block diagram of an image forming apparatus having a light scanning

FIG. 7 illustrates the operation of the compensation device and the beam deflector.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. This invention may, however, be embodied in different forms and should not be construed as limited to the embodiments set forth herein. Rather, these embodiments are provided so that this disclosure is thorough and complete and fully conveys the scope of the invention to one skilled in the art. In the drawings, the thicknesses of layers and regions are exaggerated for clarity.

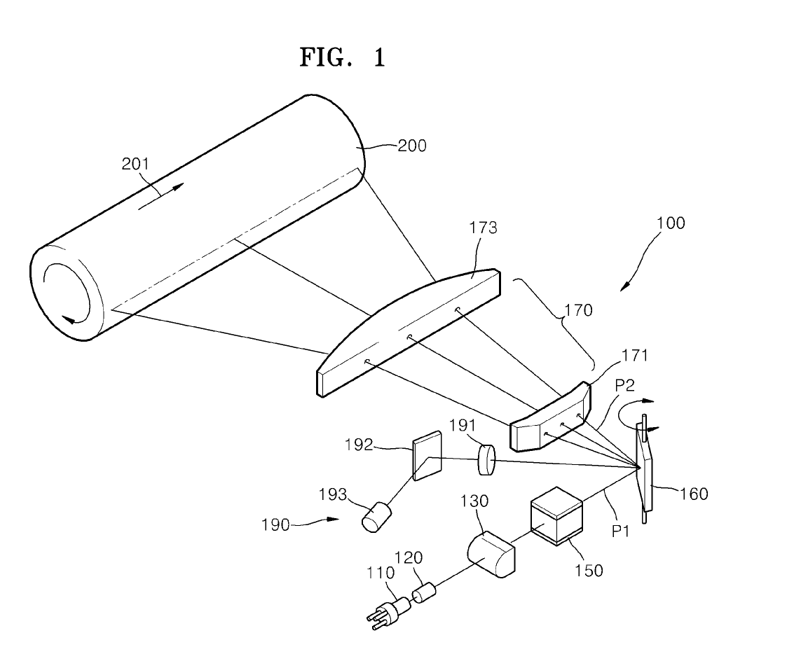

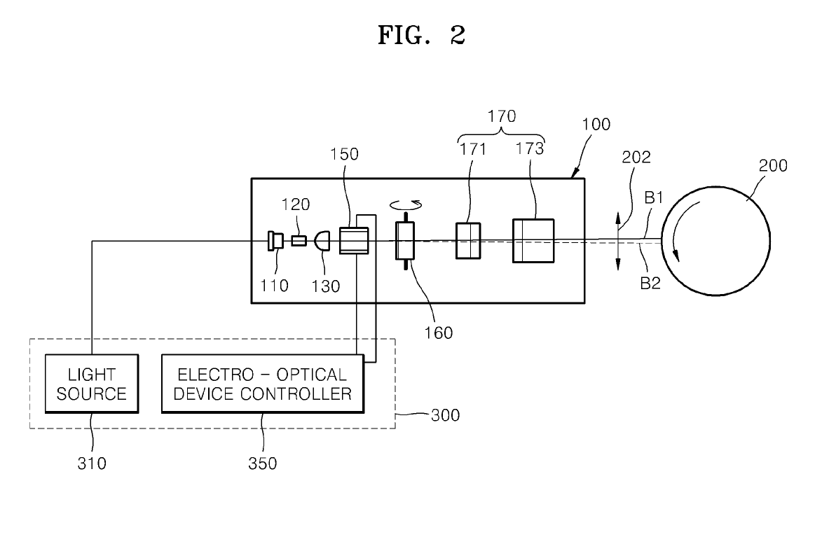

FIG. 1 is a construction view of a light scanning unit 100 according to an embodiment of the present general inventive concept, and FIG. 2 is a schematic construction diagram of a sub-scan section of the light scanning unit 100 of FIG. 1. The sub-scan section refers to a section cut in a direction orthogonal to a main scan direction in which a light scanning unit 100 scans light beams. Scanning is the process by which beams of light are direct along a surface. The main scan direction is defined as a direction in which the beam deflector 160 scans light beams, or the direction in which the beams of light move along a surface. The sub-scan direction is defined as a direction orthogonal to the main scan direction, that is, a direction of a central axis about which the beam deflector 160 rotates.

Referring to FIGS. 1 and 2, the light scanning unit 100 according to the present embodiment may include a light source 110, a collimating lens 120, a cylindrical lens 130, a compensation device 150, a beam deflector 160, an optical imaging system 170, and a synchronous signal detection system 190. A photoconductive drum 200 may have a scanned surface (or exposed surface) on which a light beam scanned by the light scanning unit 100 is directed, and a controller 300 may control the light scanning unit 100.

The light source 110 may emit light beams. For example, the light source 110 may be a semiconductor laser diode (LD) that emits laser beams.

The collimating lens 120 may condense light beams emitted by the light source 110 to be collimated or converged. The cylindrical lens 130 may condense the light beams passing through the collimating lens 120 in a direction corresponding to a main scan direction and/or a sub-scan direction so that an image can be linearly formed on an oscillating mirror of the beam deflector 160. The cylindrical lens 130 may include at least one lens. The collimating lens 120 and the cylindrical lens 160 are not indispensable elements of the present general inventive concept, and thus may be omitted. Since the collimating lens 120 and the cylindrical lens 160 are typical optical devices used for a light scanning unit, a detailed description thereof will be omitted.

The compensation device 150 may compensate for a zigzag error caused by reciprocative, or back and forth, scanning of the beam deflector 160.

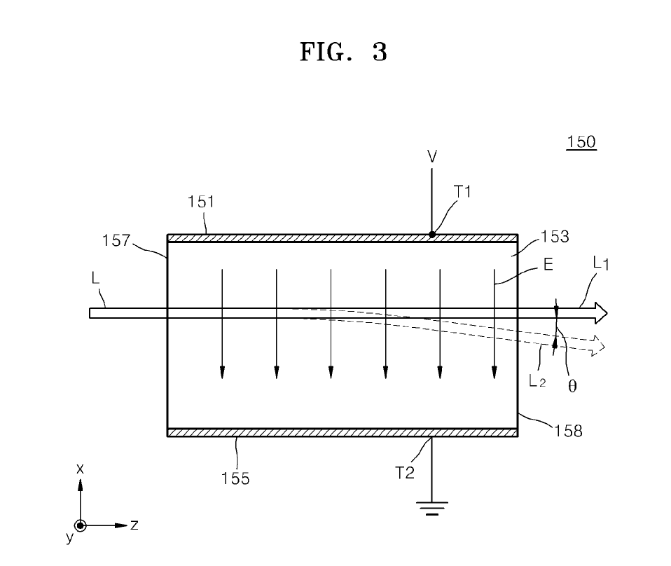

An example of the compensation device 150 is illustrated in FIG. 3. Referring to FIG. 3, the compensation device 150 may include first and second electrodes 151 and 155 and an electro-optical crystal 153 interposed between the first and second electrodes 151 and 155. The electro-optical crystal 153 is a material of which the refractive index is partially varied according to an applied voltage. For example, it is known that lithium niobate (LiNbO₃) and K—Ta—Nb crystals (e.g., KTaNbO₃ and KTa₁₋ₓNbₓO₃) (hereinafter, referred to as ‘KTN’) are electro-optical crystals. For example, the electro-optical crystal 153 may take on a rectangular parallelepiped shape having a section of FIG. 3. The first and second electrodes 151 and 155 may be prepared on both opposing surfaces of the electro-optical crystal 153 to apply a voltage to the electro-optical crystals 153. The first and second electrodes 151 and 155 may be in ohmic, or electrical, contact with the electro-optical crystal 153 so that charges can be injected into the electro-optical crystal 153 with application of a voltage. Voltage may be applied to the compensation device 150 via terminals T1 and T2. For example, as shown in FIG. 3, terminal T1 may be connected to a voltage and terminal T2 may be connected to ground potential. Terminals T1 and T1 may be located along the electro-optical crystal 153 to influence the location of the light-redirection beginning point S.

The compensation device 150 may be disposed such that a direction “x” of an electrical field E applied by the first and second electrodes 151 and 155 is orthogonal to a direction “z” in which a light beam emitted by the light source 110 proceeds. In other words, the compensation device 150 may be disposed such that the direction “x” of the electrical field E applied by the first and second electrodes 151 and 155 becomes the sub-scan direction. In this case, a direction “y” is the main scan direction in which the beam deflector 160 scans a light beam. For example, a beam of light entering the electro-optical crystal 153 of the compensation device 150 travels along a line L in direction “z.” If no voltage is applied to the electro-optical crystal 153, the beam of light will continue in a line L1 in a same direction “z” as line L. However, if a voltage is applied to the electro-optical crystal 153, the beam of light may be redirected to a line L2 in a direction that differs from line L1 by an angle θ. The beam of light travelling along line L2 will contact the beam deflector 160 at a location orthogonal to the main scan direction “y.” Specifically, the light beam will be directed by the electro-optical crystal 153 to contact the beam deflector 10 in a direction “x” orthogonal to the main scan direction “y.”

Since the first and second electrodes 151 and 155 are in electrical contact with the electro-optical crystal 153, when a voltage is applied to the first and second electrodes 151 and 155, charges may be injected into the electro-optical crystal 153. As a result, the electrical field E has a gradient distribution in the electro-optical crystal 153, that is, the intensity of the electrical field E varies gradiently in the x direction in the electro-optical crystal 153. Also a refractive index of the electro-optical crystal 153 has a gradient distribution in the electro-optical crystal 153 due to the gradient distribution of the electrical field E. If no voltage is applied to the first and second electrodes 151 and 155, the refractive index of the electro-optical crystal 153 is uniform, thus an incident light beam L would travel straight and output as a first light beam L1. However, when a voltage is applied to the first and second electrodes 151 and 155, an incident light beam L may be refracted and output as a deflected second light beam L2 due to a variation in the refractive index of the electro-optical crystal 153. In this case, a deflection angle θ of each of the first and second light beams L1 and L2 may vary with the magnitude of the applied voltage or the size of the electro-optical crystal 153. Since the size of the electro-optical crystal 153 may be fixed, the deflection angle θ of the deflected second light beam L2 may be controlled by adjusting the magnitude of the voltage applied to the first and second electrodes 151 and 155. As will be described in further detail below, the first and second light beams L1 and L2 passing through the electro-optical crystal 153 may be scanned onto the photoconductive drum 200 via the beam deflector 160. In particular, a spot of the scanned surface of the photoconductive drum 200 on which the deflected second light beam L2 is focused may move in the sub-scan direction. The movement of the deflected second light beam L2 in the sub-scan direction may allow the light scanning unit 100 to compensate for a zigzag error as described later. A method of compensating for a zigzag error by deflecting a light beam in the sub-scan direction in synchronization with the rotatable oscillation of the beam deflector 160 will be described in more detail later.

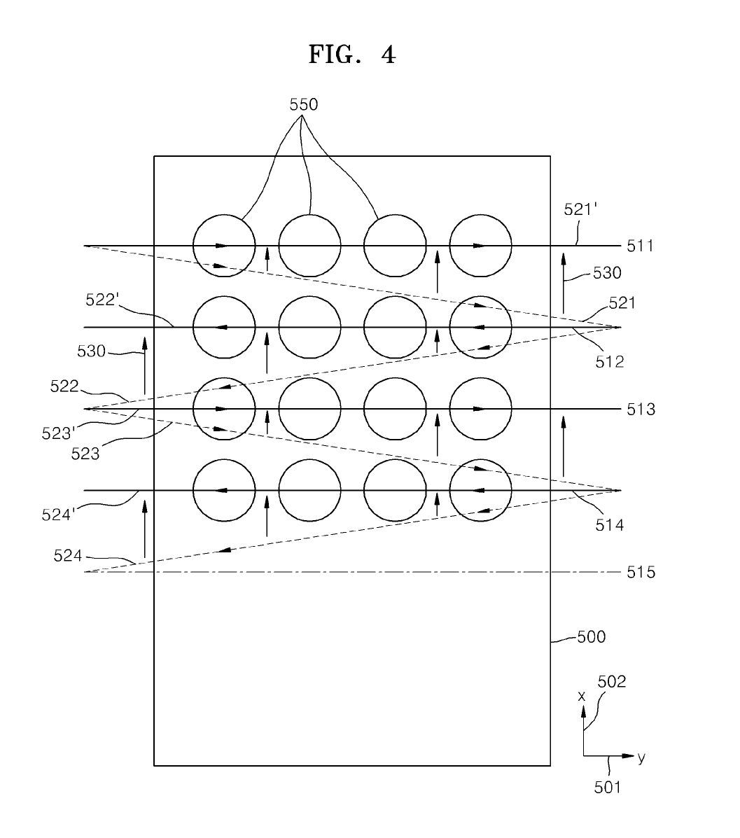

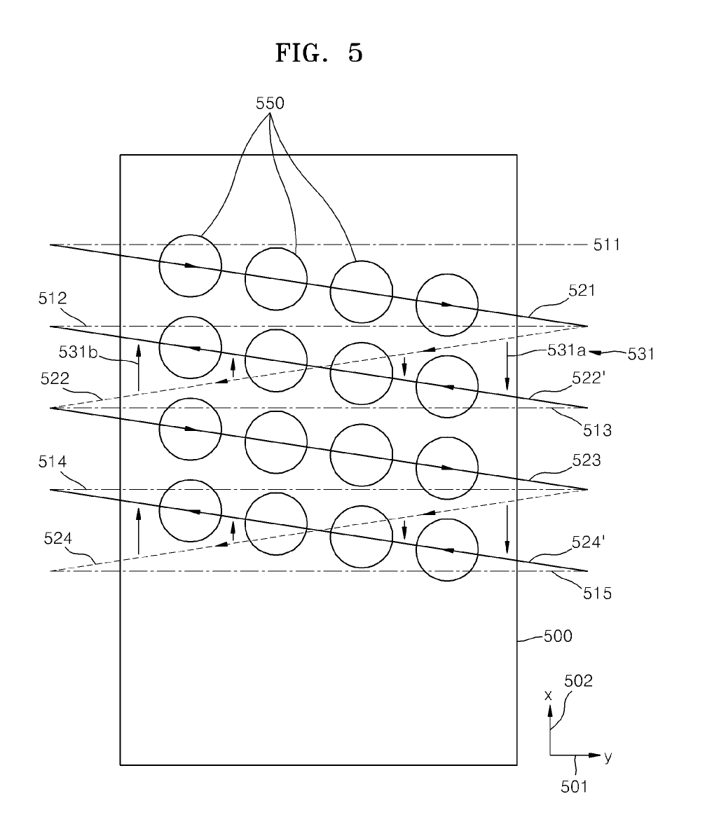

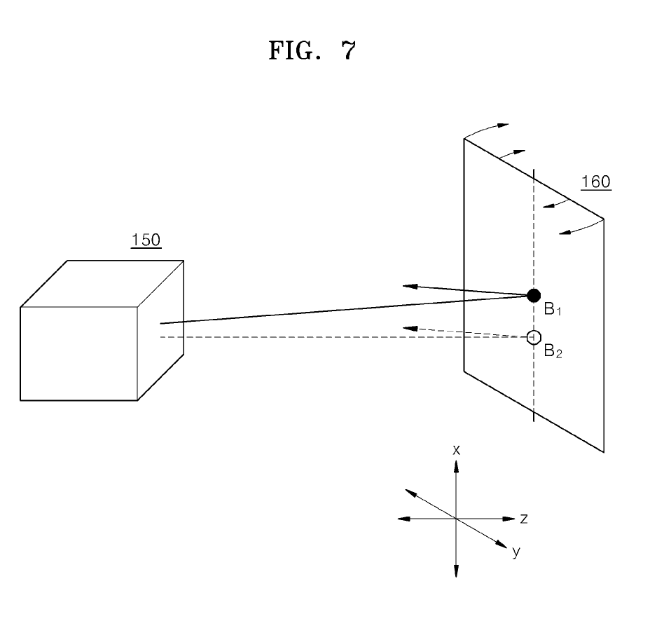

The beam deflector 160 may reciprocatively scan a light beam having passed through the compensation device 150 using the oscillation mirror of the beam deflector 160. In other words, as the beam deflector rotates along axis “x,” it receives beams of light from the light source 110 and deflects the light onto the photoconductive drum 200. The rotation of the beam deflector 160 causes a reciprocative, or back-and-forth, movement of the beams of light from the beam deflector 160 onto the photoconductive drum 200. The back- and forth movement is in a “y” direction, or main scan direction, orthogonal to the “x” direction and the light-travelling direction “z.” As shown in FIGS. 2 and 7, when the compensator 150 redirects a beam of light upon having a voltage applied across electrodes 151 and 155, the redirected beam of light contacts the beam deflector 160 at a location in the direction “x” from the location where non-redirected light beam would contact the beam deflector 160. The redirected light beam deflected by the beam deflector 160 continues on to contact the photoconductive drum 200 at a location in a direction “x,” represented by arrows 202, from a location where a non-redirected beam would have contacted the photoconductive drum, as discussed below with respect to FIGS. 4 and 5.

As shown in FIGS. 1 and 2, a beam of light between the compensation device 150 and the beam deflector 160 travels along a first beam path P1. Upon being deflected by the beam deflector, the beam of light travels along a second beam path P2. A beam B1 that exits the compensator without being redirected travels along a first plane defined by the lines P1, P2, and a beam B2 that exits the compensator having been redirected travels along a second plane defined by the redirected lines P1, P2. The first and second beams B1, B2 are separated by a distance determined by angle θ and the distance along the beam from redirection point S.

The beam deflector 160 may be a micro-electro-mechanical-system (MEMS)-type structure obtained by suspending the oscillation mirror on a torsion spring. The oscillation mirror may be driven by electrostatic force, electromagnetic force, or piezoelectric force and oscillate in a sinusoidal-wave form. When the oscillation mirror oscillates in a sinusoidal-wave form, a light beam deflected by the oscillation mirror may reciprocatively scan light beams across a surface of the photoconductive drum 200. Since the beam deflector 160 having the oscillation mirror that oscillates in the sinusoidal-wave form is known to one skilled in the art, a detailed description thereof will be omitted.

The optical imaging system 170 may image light beams reciprocatively scanned by the beam deflector 160 onto the scanned surface of the photoconductive drum 200. The optical imaging system 170 may include two imaging lenses 171 and 173. The optical imaging system 170 may be designed to perform an arcsine compensation in order to correct variable scanning speed due to sinusoidal-wave movement of the oscillation mirror of the beam deflector 160 into uniform scanning speed during scanning of a light beam. Although the optical imaging system 170 according to the present embodiment includes the two imaging lenses 171 and 172, the present general inventive concept is not limited thereto. For example, the optical imaging system 170 may include only one imaging lens. Since the optical imaging system 170 is a typical optical device applied to a light scanning unit using an oscillation mirror capable of rotatably oscillating in a sinusoidal-wave form, a detailed description thereof will be omitted.

The synchronous signal detection system 190 may include a detection lens 191, a detection mirror 192, and a synchronous signal detection sensor 193. The detection lens 191 may condense a light beam traveling at one end of a scan line of light beams, which are scanned in a main scan direction by the beam deflector 160, onto the synchronous signal detection sensor 193. The detection mirror 192 may alter a light path of the light beam to accommodate the detection lens 191 and the synchronous signal detection sensor 193. The synchronous signal detection sensor 193, for example, a photodiode (PD), may detect light beams. The beam deflector 160 may reciprocatively scan light beams due to the rotatable oscillation of the oscillation mirror. Thus, when a light beam is incident to the synchronous signal detection sensor 193, it can be noted that a scan operation performed in a first direction 201 is initiated or a scan operation performed in a second direction, which is opposite to the first direction 201, is finished. FIG. 1 illustrates the construction of the synchronous signal detection system 190 using a light beam traveling at one end of the scan line of the light beams scanned in the main scan direction, but the present embodiment is not limited thereto. For instance, the synchronous signal detection system 190 may utilize light beams traveling at both ends of the scan line of the light beams scanned in the main scan direction. When it is intended that a synchronous signal be detected using the light beams traveling at both ends of the scan line, the synchronous signal detection system 190 may be placed at each end of the scan lines.

The controller 300 may include a light source controller 310 and an electro-optical device controller 350. The light source controller 310 may control the output of a light source 310 based on given image information to modulate an output light beam. The electro-optical device controller 350 may control the magnitude of a voltage applied to the compensation device 150 in synchronization with the rotatable oscillation of the beam deflector 160 so that a light beam passing through the compensation device 150 can travel straight or be deflected in the sub-scan direction. For example, a method of synchronizing the applied voltage with the rotatable oscillation of the beam deflector 160 may be performed using a synchronous signal detected by the above-described synchronous signal detection system 190. Since the synchronous signal detected by the synchronous signal detection system 190 is a scanning synchronous signal of a light beam scanned by the beam deflector 160, the electro-optical device controller 350 may control the electro-optical device 150 using the synchronous signal. As another example, a method of synchronizing the applied voltage with the rotatable oscillation of the beam deflector 160 may be performed using a synchronous signal of image information input to the light source controller 310.

Hereinafter, a method of compensating for a zigzag error of the light scanning unit 100 according to the present embodiment will be described.

FIG. 4 is a diagram illustrating a method of compensating for a zigzag error of the light scanning unit 100 of FIG. 1, according to an embodiment of the present general inventive concept. In FIG. 4, reference numeral 500 denotes a scanned surface, 501 denotes a main scan direction “y”, and 502 denotes a sub-scan direction “x”.

The scanned surface 500 may be an outer circumferential surface of the photoconductive drum (refer to 200 in FIG. 1) and may move in the sub-scan direction 502. Reference numerals 511, 512, 513, 514, and 515 denote ideal scan lines; reference numerals 521, 522, 523, and 524 denote uncompensated scan lines; and reference numerals 521′, 522′, 523′, and 524′ denote compensated scan lines. A scanned light beam may be focused on a spot 550 of the scanned surface 500.

Referring to FIGS. 1 and 4, when no voltage is applied to the compensation device 150, the beam deflector 160 may scan a light beam in a zigzag form along the uncompensated scan lines 521, 522, 523, and 524. The uncompensated scan lines 521, 522, 523, and 524 may form a zigzag shape because the light beam is reciprocatively scanned on the scanned surface 500 moving in the sub-scan direction 502. If an image is formed along the uncompensated scan lines 521, 522, 523, and 524, the image would have a non-uniform concentration and degraded quality due to irregular intervals between the scan lines 521, 522, 523, and 524. In the present specification, a zigzag error means degradation in image quality caused by the zigzag shape of the uncompensated scan lines 521, 522, 523, and 524.

In order to compensate the scanning of a light beam scanned by the beam deflector 160, a voltage may be applied to the compensation device 150 so that the light beam scanned by the beam deflector 160 can be moved in the sub-scan direction 502 and scanned along the ideal scan lines 511, 512, 513, 514, and 515. In this case, a compensated amount 530 of the light beam in the sub-scan direction 502 may be periodically varied in synchronization with the scanning of a light beam in the main scan direction. That is, when comparing the uncompensated scan line 521 with the compensated scan line 521′, the compensated amount 530 may be zero at start positions of the scan lines 521 and 521′. As the scan operation proceeds, the compensated amount 530 may gradually increase and reach one scanning interval at end positions of the scan lines 521 and 521′. In this case, the one scan interval means an interval between the ideal scan lines 511, 512, 513, 514, and 515. Also, scan lines of all light beams that are reciprocatively scanned may be periodically compensated.

Thus, since the compensated scan lines 521′, 522′, 523′, and 524′ are consistent with the ideal scan lines 511, 512, 513, and 514, the interval between the compensated scan lines 521′, 522′, 523′, and 524′ may be made uniform, thereby improving image quality.

FIG. 5 is a diagram of the compensation device 150 used for the light scanning unit 100 of FIG. 1, according to another exemplary embodiment of the present general inventive concept. In the present embodiment, a description of reference numerals used to denote substantially the same elements as in FIG. 4 will be omitted here.

Referring to FIGS. 1 and 5, in a method of compensating for a zigzag error in the light scanning unit 100 according to the present embodiment, whether a light beam is to be moved in the sub-scan direction 502 may depend on a scan direction of a main scan direction 501 in which the light beam is scanned. Specifically, it is assumed that an arrow direction 501 of FIG. 5 is a first direction of the main scan direction, and an opposite direction to the arrow direction 501 is a second direction of the main scan direction. In this case, when a light beam is scanned in the first direction 501 of the main scan direction, the light beam may be directly scanned without a compensation process. However, when a light beam is scanned in the second direction of the main scan direction, the light beam may be moved in the sub-scan direction 502 and scanned. For example, the scan line 521 travels generally in the first direction 501 of the main scan direction, and a light beam may be directly scanned along the scan line 521 without being subjected to compensation by the electro-optical device 150. Another scan line 522 travels generally in the opposite direction of the main scan direction, and a light beam corresponding to scan line 522 may be scanned along the compensated scan line 522″. The compensated scan line 522″ may be set to be parallel to the scan lines 521 and 523. In FIG. 5, assuming that the arrow direction 502 is the first direction of the sub-scan direction and an opposite direction to the arrow direction 502 is the second direction, a light beam corresponding to scan line 522″ may be adjusted in a first direction 531a at a start position of the scan line 522″ and may be adjusted in a second direction 531b at an end position of the scan line 522″. An interval measured in the sub-scan direction between the uncompensated scan line 522 and the compensated scan line 522″ may correspond to a compensated amount 531 of a light beam.

Although the present embodiment describes a case where a light beam is compensated only when the light beam is scanned in the direction opposite the main scan direction, the present general inventive concept is not limited thereto. That is, a light beam may be compensated when the light beam is scanned in the first direction of the main scan direction, in a direction opposite the first direction, or both. According to the method of the present embodiment, a light beam may be slightly inclined and scanned as illustrated with solid lines 521, 522″, 523, and 524″ of FIG. 5. In this case, the interval between the compensated scan lines 521, 522″, 523, and 524″ may be made uniform, thereby enhancing image quality.

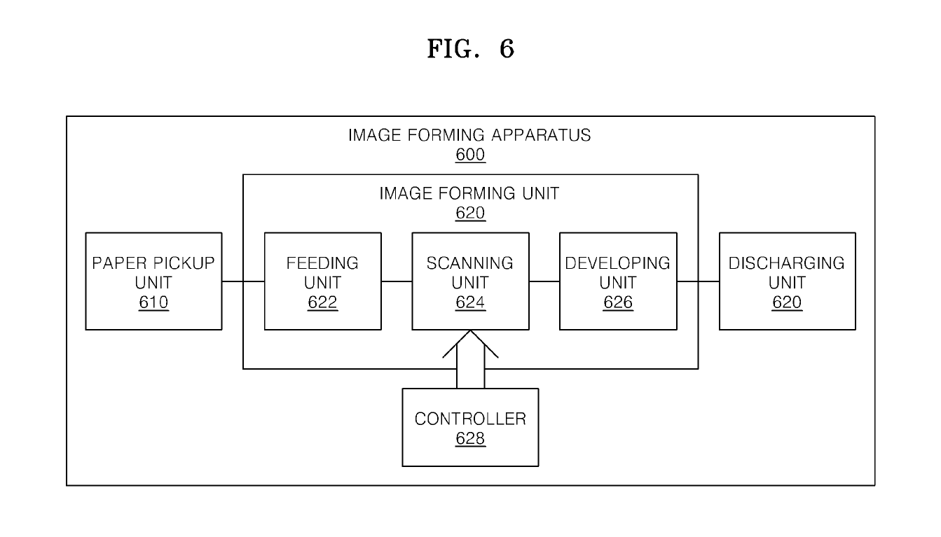

The light scanning unit 100 of the present embodiment may be applied to an electrophotographic imaging apparatus, such as a copying machine, a printer, or a facsimile, which is capable of reproducing an image on printing paper. FIG. 6 illustrates an image forming apparatus 600, such as a copying machine, printer, for facsimile. The image forming unit may comprise a paper pickup unit 610 to pickup paper or another article to be scanned or printed on. Examples of other articles to be printed upon may include transparencies, cardstock, cloth, and the like. An image forming unit 600 may include a feeding unit 622 to retrieve the paper from the paper pickup unit 610, a scanning unit 624 which may include a light scanning unit 100 as shown in FIGS. 1-5, and a developing unit 624. The developing unit may include a photoconductive drum 200 and developing elements such as a cartridge (not shown) containing toner or another developer and a drum (not shown) or other application means to apply the toner to the photoconductive drum 200. An electrostatic latent image may be formed on an outer circumstantial surface (i.e., scanned surface) of the photoconductive drum 200 due to light scanned by the light scanning unit 100. The electrostatic latent image formed on the photoconductive drum 200 may be developed using a toner supplied by the cartridge (not shown), and the developed image may be transferred on printing paper by means of a transfer medium (not shown). In this case, the developing unit 624 or the transfer medium may be an ordinary developing unit or transfer medium adopted for a typical imaging apparatus.

The image forming unit 620 may further comprise a controller 621 for controlling operation of the feeding unit 622, scanning unit 624, and developing unit 626. Upon completion of a scanning operation, the printing paper or other writeable medium may be transferred to a discharging unit 630 to be discharged from the image forming apparatus 600.

As described above, since the compensation device 150 having electro-optical characteristics may be used to compensate for a zigzag error caused by reciprocative scanning of the oscillation mirror, the imaging apparatus having the light scanning unit 100 according to the present embodiment may improve image printing quality. A structure in which the light scanning unit 100 and the photoconductive drum 200 is combined with the transfer medium is known to those skilled in the art, and thus a detailed description thereof will be omitted.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A light scanning unit for scanning a light beam in a main scan direction orthogonal to a sub-scan direction onto a scanned surface moving in the sub-scan direction, the light scanning unit comprising:
a light source configured to emit a light beam;
a beam deflector configured to receive the light beam emitted by the light source and to reciprocatively scan the light beam onto the scanned surface, the beam deflector including an oscillation mirror configured to reciprocatively rotate; and
a compensation device configured to compensate for a zigzag error caused by reciprocative rotation of the beam deflector.

2. The light scanning unit of claim 1, wherein the compensation device comprises:
an electro-optical crystal having a refractive index that varies according to a voltage applied to the electro-optical crystal; and
an electrode unit configured to apply a voltage to the electro-optical crystal.

3. The light scanning unit of claim 2, wherein the electro-optical crystal is one of a lithium niobate (LiNbO₃) and a K—Ta—Nb crystal (KTN).

4. The light scanning unit of claim 1, wherein the compensation device is located in a light path interposed between the light source and the beam deflector.

5. The light scanning unit of claim 1, wherein the compensation device compensates scan lines of light beams formed on the scanned surface due to the reciprocative scanning of the beam deflector to be parallel to the main scan direction.

6. The light scanning unit of claim 1, wherein the compensation device allows a first light beam corresponding to a light beam scanned onto the scanned surface in a first direction to travel straight, thereby forming a first scan line on the scanned surface, and the compensation device adjusts a second light beam corresponding to a light beam scanned onto the scanned surface in a second direction opposite to the first direction to travel along a scan line parallel to the first scan line.

7. The light scanning unit of claim 1, further comprising a synchronous signal detection system configured to detect a signal synchronized with the reciprocative scanning of the beam deflector.

8. The light scanning unit of claim 1, further comprising a collimating lens located between the light source and the compensation device and configured to collimate a light beam.

9. The light scanning unit of claim 1, further comprising a cylindrical lens located between the light source and the compensation device and configured to condense a light beam in the sub-scan direction onto the beam deflector.

10. The light scanning unit of claim 1, further comprising an optical imaging lens configured to image light beams from the beam deflector onto the scanned surface, so that the light beams scan onto the scanned surface at uniform speed.

11. An imaging apparatus comprising:
a photoconductive medium having a scanned surface; and
a light scanning unit configured to scan a light beam in a main scan direction orthogonal to a sub-scan direction onto the scanned surface, the scanned surface moving in the sub-scan direction,
wherein the light scanning unit comprises:
a light source configured to emit a light beam;
a beam deflector configured to receive the light beam emitted by the light source and reciprocatively scan the light beam onto the scanned surface, the beam deflector including an oscillation mirror configured to rotate reciprocatively; and
a compensation device configured to compensate for a zigzag error due to reciprocative rotation of the beam deflector by deflecting a light path of a light beam in the sub-scan direction in synchronization with the rotatable oscillation of the oscillation mirror.

12. The apparatus of claim 11, wherein the compensation device comprises:
an electro-optical crystal having a refractive index that varies according to an applied voltage; and
an electrode unit configured to apply a voltage to the electro-optical crystal.

13. The apparatus of claim 12, wherein the electro-optical crystal is one of a lithium niobate (LiNbO₃) and a K—Ta—Nb crystal (KTN).

14. The apparatus of claim 11, wherein the compensation device is located in a light path interposed between the light source and the beam deflector.

15. The apparatus of claim 11, wherein the compensation device compensates scan lines of light beams formed on the scanned surface due to the reciprocative scanning of the beam deflector to be parallel to the main scan direction.

16. The apparatus of claim 11, wherein the compensation device allows a first light beam corresponding to a light beam scanned in a first direction to travel straight, thereby forming a first scan line on the scanned surface, and the compensation device adjusts a second light beam corresponding to a light beam scanned in a second direction opposite to the first direction to travel along a scan line parallel to the first scan line.

17. The apparatus of claim 11, wherein the light scanning unit further comprises a synchronous signal detection system configured to detect a signal synchronized with the reciprocative scanning of the beam deflector.

18. The apparatus of claim 11, wherein the light scanning unit further comprises a collimating lens located between the light source and the compensation device and configured to collimate a light beam.

19. The apparatus of claim 11, wherein the light scanning unit further comprises a cylindrical lens located between the light source and the compensation device and configured to condense a light beam on the beam deflector in the sub-scan direction.

20. The apparatus of claim 11, wherein the light scanning unit further comprises an optical imaging lens configured to image light beams from the beam deflector onto the scanned surface, so that the light beams scan onto the scanned surface at uniform speed.

21. A method of compensating for a zigzag error of a light scanning unit for reciprocatively scanning a light beam onto a scanned surface in a main scan direction orthogonal to a sub-scan direction, the scanned surface moving in the sub-scan direction, the method comprising deflecting a light beam incident to an oscillation mirror in the sub-scan direction in synchronization with rotatable oscillation of the oscillation mirror to compensate for a zigzag error caused by reciprocative scanning of the oscillation mirror.

22. The method of claim 21, wherein deflecting the light beam comprises applying a voltage to an electro-optical crystal having a reflective index that varies according to the voltage so that a light beam passing through the electro-optical crystal travels is deflected in the sub-scan direction.

23. The method of claim 22, wherein the electro-optical crystal is one of a lithium niobate (LiNbO₃) and a K—Ta—Nb crystal (KTN).

24. The method of claim 21, wherein the oscillation mirror is a beam deflector, the oscillation of the beam deflector causes reciprocative scanning of light beams onto the scanned surface, and scan lines formed on the scanned surface due to the reciprocative scanning of the beam deflector are compensated to be parallel to the main scan direction.

25. The method of claim 21, wherein first light beam corresponding to a light beam scanned in a first direction is allowed to travel straight, thereby forming a first scan line on the scanned surface, and a second light beam corresponding to a light beam scanned in a second direction opposite to the first direction is deflected to travel along a scan line parallel to the first scan line.

26. A method of compensating for a zigzag error of a light scanning unit comprising a light source, a compensator, and a beam deflector, the method comprising:
emitting a light beam from the light source;
deflecting the light beam from the light source with the beam deflector to reciprocatively scan the light beam onto a scanned surface, the scanned surface moving in a first direction; and
redirecting the light beam from the light source in the first direction with the compensator in synchronization with the reciprocative scanning of the beam deflector to generate adjacent scan lines traveling in opposite directions parallel to each other on the scanned surface.

27. The method of claim 26, wherein the scan lines on the scanned surface are orthogonal to the first direction.

28. The method of claim 26, wherein the compensator is located along a path of the light beam between the light source and the beam deflector.

29. The method of claim 28, wherein the compensator comprises an electro-optical crystal having a reflective index that varies according to a voltage applied to the electro-optical crystal, the method further comprising:
applying a voltage to the electro-optical crystal to direct the beam of light onto the beam deflector at an angle different from an angle at which the beam of light entered the electro-optical crystal from the light source.

30. A light scanning unit usable with a photoconductive drum of an image forming apparatus, comprising:
a light source to emit a light beam;
a beam deflector to direct the light beam toward the photoconductive drum, to scan the light beam onto the photoconductive drum in a first direction orthogonal to the rotation axis of the beam deflector;
a compensation device to direct the light beam in a second direction parallel to the rotation axis direction of the beam deflector.

31. The light scanning unit according to claim 30, wherein the compensation device is located between the light source and the beam deflector.

32. An image forming apparatus, comprising:
a receiving unit for receiving a printable article to have an image formed thereon;
a developing unit comprising a developer storage area and a photoconductive drum; and
a light scanning unit comprising:
a light source configured to emit a light beam;
a beam deflector to receive the light beam emitted by the light source and to reciprocatively scan the light beam onto a surface of the photoconductive drum, the beam deflector including an oscillation mirror to reciprocatively rotate; and
a compensation device to compensate for a zigzag error caused by reciprocative
rotation of the beam deflector and rotation of the photoconductive drum,
wherein the developing unit is capable of forming an image corresponding to the light scanned onto the photoconductive drum onto the printable article.
